(19) United States
(12) Patent Application Publication
(10) Pub. No.: US 2021/0025140 A1
(43) Pub. Date: Jan. 28, 2021

(54) AUTOMATIC TOOL TILT COMMAND SYSTEM

(71) Applicant: DANFOSS POWER SOLUTIONS INC., Ames, IA (US)

(72) Inventor: Christian S. Daley, Ames, IA (US)

(21) Appl. No.: 16/934,116

(22) Filed: Jul. 21, 2020

Related U.S. Application Data
(60) Provisional application No. 62/876,905, filed on Jul. 22, 2019.

(51) Int. Cl. E02F 9/22; F15B 13/044

(52) U.S. Cl. CPC E02F 9/2285; F15B 13/044

(57) ABSTRACT

Automatic tilt command system of a hydraulically driven boom moveably connected with one end to a chassis of a working machine, wherein a tiltable tool is attachable to the other end. The system further comprises a first electronic control valve for controlling a fluid flow to and from a boom lift cylinder for moving of the boom and a second electronic control valve for controlling a fluid flow to and from a tilt cylinder for tilting the tool. A control unit receives input signals with regard to moving the boom and transmits based on the received input signals actuating signals to the first electronic control valve in order to move the boom. In parallel the control unit transmits tilting signals to the second electronic control valve which are based on a predetermined fluid flow ratio defined by the fluid flow for the boom movement and the fluid flow for tool levelling, so that the tool maintains its inclination angle with respect to the horizontal.

### CROSS REFERENCE TO RELATED APPLICATION

This application claims the benefit of the priority of U.S. Provisional Application No. 62/876,905 filed on Jul. 22, 2019, the content of this application is hereby incorporated by reference in its entirety.

### BACKGROUND OF THE INVENTION

The present invention is directed to an automatic tilt command system, e.g., for a telehandler, that eliminates a compensation cylinder or an angle sensor and feedback signals for compensating change in the angle between a boom and a tool attached thereto when the boom is lifted or lowered and in order to keep the inclination angle of the tool with respect, e.g., to the horizontal or vertical direction stable.

The following invention is described exemplarily by the help of a telehandler equipped with a tiltable tool, e.g. a fork, for moving load, e.g. material on pallets from one place to another. However the invention is not limited thereto and, e.g., applies also to tractors, excavators and other working machines equipped with a boom and a tiltable tool attached to the free end of the boom, for instance a road loader equipped with a fork, a bucket or a shovel. Another application example for the inventive tilt command system would be an earth drilling machine where the angle between the boom and the auger changes continuously during the drilling operation, however the drilling direction has to be maintained always. In all these applications the control of the angle between the boom and the tool, i.e. the inclination of the fork, the bucket, the shovel, or the auger has to be controlled and eventually adjusted in order that the tool inclination is kept stable with regard to absolute directions, as the horizontal or the vertical direction, even when the angle of the boom with respect to the chassis of the working machine is changing, e.g. when lifting the load or advance drilling.

Forklifts, and in particular telehandler forklifts, are well-known in the art and are used to lift and move materials over short distances. Forklifts have become an indispensable piece of equipment in manufacturing and warehousing. Forklifts are rated for loads at a specified maximum weight and a specified forward center of gravity. Loads must not exceed these specifications.

One critical characteristic of a forklift is its instability. The forklift and load must be considered a unit with a continually varying center of gravity with every movement of the working machine and the load, in particular with telehandlers as the boom is moveable in a telescopic manner also, thereby increasing the lever arm of the load. A forklift must never negotiate a turn at speed with a raised load, where centrifugal and gravitational forces may combine to cause a disastrous tip-over accident. The forklift is designed with a load limit for the forks which is decreased with fork elevation and undercutting of the load (i.e., when a load does not butt against the fork “L”). A loading plate for loading reference is usually located on the fork lift.

As a critical element of warehouses and distribution centers, it is imperative that a forklift's structure be designed to accommodate for efficient and safe movement. In addition to a control to raise and lower the forks (also known as blades or tines) or other tools, the operator can tilt the mast, e.g. of a warehouse forklift, to compensate for a load's tendency to angle the blades toward the ground and risk slipping off the forks. For this purpose working machines comprise a hydraulic cylinder for moving the boom/mast with respect to the chassis of the working machine, e.g. for raising or lowering the load, and a tilt cylinder to keep the load in the desired inclination, e.g. in the horizontal position. The boom moving/lifting cylinder is attached with one end to the chassis and with its other end to the boom. At the other end of the boom, between the “free end” of the boom and the tool, e.g. a fork, a tilt cylinder is located for setting/adjusting the tilt/inclination of the tool with respect to an absolute direction, e.g. the horizontal or the vertical direction.

In order to maintain the inclination/tilt of the fork/tool stable during operation of the working machines, these working machines, e.g. a telehandler, comprise a tilt compensation system. Such a usually hydraulically driven tilt compensation system ensures the inclination angle of the fork with respect to the horizontal stable when the boom is raised or lowered, extended or retracted in the (telescopic) longitudinal direction. Tilt compensation also provides for an ability to operate on uneven ground. Such a tilt or inclination compensation system applies in all working machines in which an orientation/inclination of the tool has to be kept constant during operation of the working machine, be it a fork for material handling or a shovel for loading gravel onto a lorry, or in case of an earth drilling machine, to maintain the drilling angle constant.

Presently in the state of the art, tilt compensation cylinders are used to keep the tool inclination with respect to the horizontal or vertical when the boom of a telehandler is raised and lowered. Such a tilt compensation cylinder is mechanically linked and designed to extend and retract as the lift/moving cylinder for the boom is extended or retracted when the boom is commanded, e.g. by an operator, to raise, to lower, to extend, or to retract. The compensation cylinder then enables a compensation fluid flow to the tilt cylinder in order to maintain the fork inclination stable.

Other prior art, e.g., utilizes level sensors on the tool to keep it level or at some determined angle relative to the chassis or the absolute horizontal or vertical direction by feeding back signals to a control unit for tilt angle compensation by means of controlling a fluid flow to and from the tilt cylinder to retract or extend. The use of tilt compensation cylinders and level sensors, however, adds complexity and expense to the design and manufacture of current working machines equipped with a boom to which a tool is attached to, and whose inclination angle has to be controlled during operation of the working machine.

Creating a solution that does not use a tilt compensation cylinder nor a level sensor with feedback system but maintains current performance of the tilt cylinder is desired. Eliminating the compensation cylinder or sensors and feedback system provides an important cost savings to the overall working machine particularly when functionality is to be maintained.

Accordingly, an objective of the present invention is to provide an automatic tilt command system that eliminates the use of a tilt compensation cylinder and a level sensor.

Another objective of the present invention is to provide an automatic tilt command system that is less expensive to manufacture while machine functionality is maintained.

### DETAILED DESCRIPTION OF THE INVENTION

The solution to the above referenced problems involves, according to claim 1 of the invention, sending based on a command to move the boom automatically generated command signals to electronic control valves in order to permit hydraulic flow to and from the boom moving cylinder and to and from the tool tilt cylinder with a predetermined ratio. Thereby the predetermined ratio is determined by the design of the working machine as every boom movement requires a correspondent tilt compensation. With the movement of the boom the angle between the boom and the chassis of the working machine changes. In order to keep the inclination of the tool with respect to the horizontal or vertical constant the angle between the boom and the tool has to be changed as well. For instance, when the boom is raised an angle between the boom and the chassis increases, and thus an angle between the boom and the tool has to be reduced in order that the tool maintains its inclination with regard to the horizontal. This angle compensation requires a hydraulic fluid flow for tilt compensation and is a fixed percentage of the hydraulic fluid flow necessary for the boom movement. This percentage at least over large parts of the operational range of the boom movement remains more or less constant and can be determined by testing, mathematical calculation, or simulation. Hence, the predetermined ratio according to invention is a percentage between the fluid flow for boom movement and the fluid flow required for tilting the tool in order to keep the inclination of the tool with respect to an absolute direction constant.

For controlling these fluid flows for moving the boom and tilting the tool the invention uses for controlling each fluid flow an electronic control valve, which valves are controlled by a control unit providing correspondent electric signals for feeding or discharging hydraulic fluid to and from the moving cylinder of the boom and to and from the tilt cylinder for tilting the tool. This control unit is designed to receive the commands for moving the boom, to determine the correspondent fluid flows to both the moving/lift cylinder and the tilt cylinder based on the predetermined flow ratio as indicated above, and to transmit corresponding signals to the electronic control valves for permitting adequate fluid flows to and from the movements cylinder and to and from the tilt cylinder.

In difference to the state of the art neither a compensation cylinder nor sensors for feeding back the tool inclination is necessary any longer. Furthermore, existing control units can be used and have to be designed only in a manner that they are capable to transmit corresponding electric signals to the electronic control valves for adjusting the tool inclination to the movement of the boom. For these signal transmissions common known techniques are applicable as transmission by wire, wireless transmission, transmission by serial or parallel bus systems, etc.

Naturally, the electronic control valves have to be equipped with correspondent receivers for receiving the actuating signal to move the boom and the levelling signal to perform the tilt compensation. Here the electronic control valves, for instance, comprise electronic actuators, like solenoids to enable the commanded fluid flows to the respective cylinders in order to fulfil the initial operation input command to move/lift/lower the boom while keeping the inclination angle of the tool as initially adjusted.

As the cylinders for boom movement and for tool inclination are commonly double-acting cylinders, the use of ¾-way-valves is possible. Such directional valves comprise a spool for opening and closing the adequate fluid paths, preferable in a proportional manner corresponding to the actuation and/or the inclination signal. For doing this, solenoids can be applied, which shift the spool proportional to the actuation or levelling signal to enable the correspondent boom movement with tool inclination compensation. In order to bring or hold these electronic control valve in their initial position, where fluid flows via the electronic control valves is disabled, centring valve springs or pressure compensated valve spools can be used. Further, pressure compensated valves are used preferably, when load independent flow functionality should be provided by the inventive automatic compensation system for tool inclination.

Preferably an electronic load sharing unit provides that there is always sufficient fluid flow available for both functions so that the predetermined flow ratio can be always maintained. Here the electronic load sharing unit preferably controls the hydraulic system of the working machine in order that the total pump flow commanded for the operation of all working machine functions does not exceed the actual pump flow output or the maximum capacity of the pump. Here pump speed, engine speed as well as pump and engine efficiencies should be considered. Hence the control unit for tilt compensation applies the predetermined flow ratio for tilt compensation based on available hydraulic flow determined by the load sharing unit.

In operation of the working machine, e.g., the operator transmits via a joystick command to the control unit, e.g., for moving the boom only, while the inventive tilt compensation system adapts the angle of the tool automatically in order to maintain the tool inclination constant with respect to the horizontal, however, the operator is still able to make adjustments to the tilt function via a joystick. This means that the operator is capable to command only the tool tilt function without moving the boom. If the operators do not wish to change the tool inclination the inventive system corrects automatically the angle between the boom and the tool so that the tool stays level, for instance. For this new system to function correctly, it is preferred that the flow ratio of boom raise flow to tool tilt flow is very close to constant for all positions of the lift cylinder to keep the tool inclination constant, e.g. level.

### BRIEF DESCRIPTION OF THE DRAWINGS

FIG. 1 is a schematic view of a first embodiment of an automatic tilt command system according to the invention; and

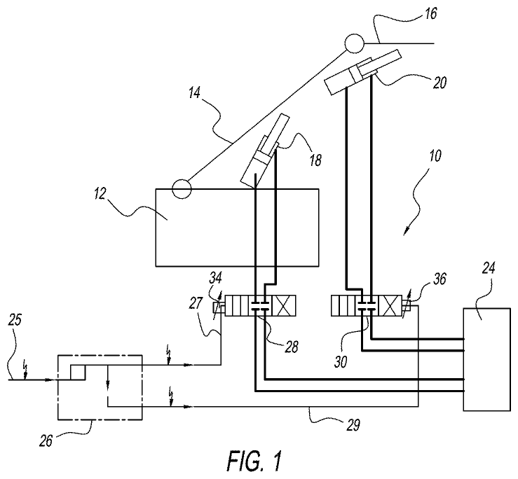

FIG. 2 is a schematic view of a second embodiment of an automatic tilt command system according to the invention.

### DETAILED DESCRIPTION OF THE PREFERRED EMBODIMENTS

Referring to the Figures, in a preferred embodiment an automatic tilt command system 10 is used with a telehandler having a chassis 12. Moveably connected to the chassis 12 is a boom 14 and moveably connected to the boom 14 is a tool 16, e.g. a fork 16. Connected to and extending between the chassis 12 and the boom 14 is a boom lift cylinder 18, for lifting or lowering the boom 14. Connected to and extending between the boom 14 and the tool 16 is a tool tilt cylinder 20 for setting/adjusting the inclination of the tool 16 with respect to the horizontal direction, when the boom is lifted or lowered.

The system further includes a hydraulic system 24, a control unit 26, and a first electronic control valve 28 and a second electronic control valve 30, which are preferably pressure compensated valves. The first electronic control valve 28 controls the flow of hydraulic fluid between the hydraulic system 24 and the lift cylinder 18, while the second electronic valve 30 controls the flow of fluid between the hydraulic system 24 and the tilt cylinder 20.

In operation, an input command for moving the boom 14 is sent to the controller 26 from an operator using a joystick or the like via an input signal line 25. The controller 26 calculates flow requirements for the lift cylinder 18 and the tilt cylinder 20 based upon the input command and a predetermined flow ratio necessary to fulfill the required boom movement and to keep the inclination of the tool with regard to the horizontal direction. For doing this, based upon the calculated flow requirements, boom actuating signals are sent from the controller 26 to the first electronic control valve 28 via an actuating signal line 27 and in parallel tool tilting signals are sent to the second electronic control valve 30 via a levelling signal line 29.

Based upon these signals, each electronic control valve 28 and 30 permits the calculated amount of fluid to flow between the hydraulic system 24 and the lift and tilt cylinders 18 and 20 which causes the boom 14 to be raised or lowered while the tool 16 is maintained in its inclination.

In a further preferred embodiment the actuating signal transmitted by the control unit 26 via actuating signal line 27 is received by a lift actuator 34 for actuating the first electronic control valve 28 to fulfil the lift requirement according to the input command signal to the control unit 26. In parallel to the transmitted actuation signal via the levelling signal line 29 a tilt signal is transmitted by the control unit 26 to a levelling actuator 36 for actuating the second electronic control valve 30 in order to maintain the inclination of the tool 16 with respect to the horizontal as it was before the input command signal was sent to the control unit 26. So, the control unit 26 generates a second, parallel tilt signal to compensate the change in the angle of tilt which would occur when the boom is raised or lowered without such compensation. For such a compensation the prior art uses compensation cylinders or sensors which feed back a change of tilt angle, which have to be corrected in order to prevent falling down of the load from the tool 16.

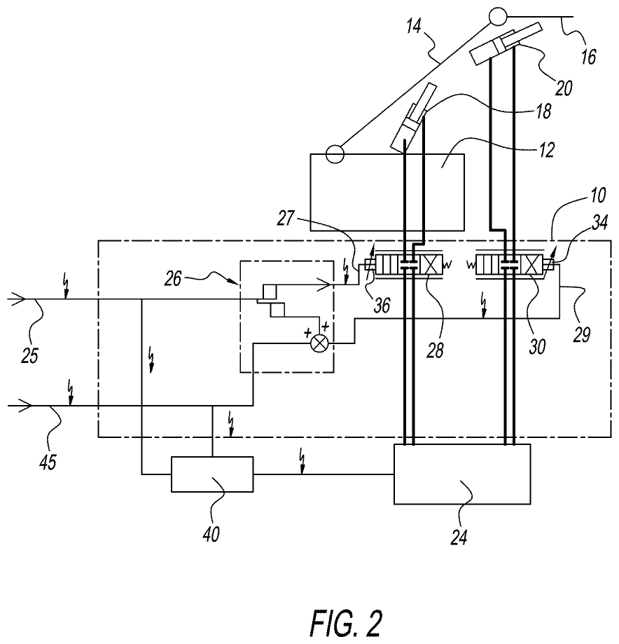

According to the invention the operator is still able to make adjustments to the tool tilt function, e.g. via a tool tilt input line 45. This is shown with the embodiment of FIG. 2. Hence an operator is still able to set the inclination of the tool 16 manually according to operational requirements for the working machine or to correct based on visual observation the inclination angle of the tool 16. To this effect, the inventive automatic tilt command system is an open loop control system.

In the embodiment of FIG. 2 the inventive automatic tilt command system is influenced/controlled by an electronic load sharing system 40 which automatically adapts the input command for moving the boom to current ability of the hydraulic system 24 such that the total commanded pump flow of the working machine does not exceed the capacity of the hydraulic system. This adaptation is based, e.g., on pump speed, which usually depends on the engine speed, and is controlled to provide maximum overall efficiency of the working machine. Hence, electronic load sharing makes it possible to always have sufficient flow so that the predetermined flow ratio for tool tilt compensation is always maintained. However the electronic load sharing system controls, e.g., the speed with which the movement of the boom with correspondent tilt compensation is performed. The ability for the operator to make adjustments to the tilt function via joystick will still be functional. Also, if the predetermined ratio of the boom movement flow to the tilt flow is not constant for all positions of boom movement, neither compensation cylinders nor position sensors or angle sensors will be necessary for automatic tool leveling, as operator corrections of the tilt angle are always possible, e.g. based on visual control of the operator.

In another embodiment of the invention, which is not shown in the Figures, the automatic tilt system 10 can be applied also to telescopic booms having more than one boom element 15 forming the moveable boom 14. In such an embodiment the boom 14 can be raised or lowered by the boom lift cylinder 18 and can be retracted or extended in its longitudinal direction, e.g., by a relative movement cylinder 22 moving the boom elements 15 relative to each other. In this case according to the invention an additional electronic control valve 32 is controlled by the control unit 26 as well such that both cylinders for moving the boom are considered by the predetermined flow ratio, which is defined by the total flow fluid required for boom movement and the fluid flow necessary for tilt angle compensation.

The inventive automatic tilt command system is also applicable with working machines showing foldable booms in an analogous way, as the fluid flow necessary for the boom movement, respectively, the relative movements of the boom elements 15, driven by two or more boom movement cylinders 18 and 22 form together a total fluid flow which is the base for determining the predetermined flow ratio in order to compensate the tilt angle change of the tool with respect to the boom in order to keep the absolute inclination with respect to the horizontal direction stable, e.g. levelled.

From the above discussion and accompanying figures and claims it will be appreciated that the automatic tilt command system 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. Automatic tilt command system of a hydraulically driven boom moveably connected with one end to a chassis of a working machine, wherein a tiltable tool is attachable to the other end, the system further comprising:
a first electronic control valve for controlling a fluid flow to and from a boom lift cylinder for moving of the boom;
a second electronic control valve for controlling a fluid flow to and from a tilt cylinder for tilting the tool; and
a control unit for receiving input signals with regard to moving the boom, which control unit transmits based on the received input signals actuating signals to the first electronic control valve in order to move the boom, and transmits in parallel corresponding tilting signals to the second electronic control valve, which are based on a predetermined fluid flow ratio defined by the fluid flow for the boom movement and the fluid flow for tool levelling, so that the tool maintains its inclination angle with respect to the horizontal.

2. System according to claim 1, wherein the input signals are transmitted via a joystick command by an operator.

3. System according to claim 1, wherein the first electronic control valve and the second electronic control valve can be actuated by means of solenoids receiving the actuating signals or the levelling signals, respectively.

4. System according to claim 1, wherein the input signals, the actuation signals, and/or the levelling signals to and/or from the control unit are transmitted by wire and/or wirelessly and/or by a bus system.

5. System according to claim 1, wherein the spools of the first electronic control valve and the second electronic control valve are pressure compensated and/or centred in the initial position by valve springs.

6. System according to claim 1, wherein an electronic load sharing unit ensures that there is always sufficient fluid flow through both the first electronic control valve and the second electronic control valve, so that the predetermined fluid flow ratio is always maintained, when moving the boom.

7. System according to claim 1, wherein the boom comprises at least two boom elements which are movable relative to each other by means of at least one relative movement cylinder, wherein a fluid flow to and from the at least one relative movement cylinder is controlled by at least one additional electronic control valve.

8. System according to claim 7, wherein the boom is configured for telescopic extension and retraction and the at least one relative movement cylinder extends and retracts the telescopic boom.

9. System according to claim 1, wherein the inclination angle of the tool can be adjusted via a joystick command by an operator independent to the commands for moving the boom.

10. System according to claim 1, wherein the tool is a fork of a telehandler, or a shovel, a grapple, a breaker of an excavator, or an auger of a drilling machine, or the like.

11. Working machine comprising:
a hydraulically driven boom moveably connected with one end to a chassis of the working machine, and with a tiltable tool attached at the other end, and an automatic tool tilt control system according to claim 1,
wherein a hydraulic system for providing the lift cylinder via the first electronic control valve and for providing the tilt cylinder via the second electronic control valve with hydraulic fluid flow is controlled by an electronic load sharing unit for ensuring sufficient fluid flow to both the lift cylinder and the tilt cylinder so that a predetermined fluid flow ratio defined by the fluid flow for the boom movement and the fluid flow for tool levelling can be met and so that the tool maintains its inclination angle with respect to the horizontal during boom movement.

12. Working machine according to claim 11, wherein the tool can be attached to and detached from the boom by means of a hydraulic quick coupling unit.
